(19) United States
(12) Patent Application Publication
(10) Pub. No.: US 2007/0072114 A1
(43) Pub. Date: Mar. 29, 2007

(54) Infrared-sensitvive planographic printing plate precursor

(75) Inventor: Akira Nagashima, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/523,529

(22) Filed: Sep. 20, 2006

(30) Foreign Application Priority Data
Sep. 26, 2005 (JP) 2005-278800

(51) Int. Cl. G03C 1/00

(52) U.S. Cl. 430/270.1

(57) ABSTRACT

According to an aspect of the invention, there is provided an infrared-sensitive planographic printing plate precursor including: a support; a recording layer on one surface of the support, which recording layer contains a water-insoluble and alkali-soluble resin and an infrared absorber, and is capable of forming an image by infrared irradiation; and an organic polymer layer on the other surface of the support, which organic polymer layer is formed by coating and drying a solution that contains at least one organic polymer selected from epoxy resins and resole resins, and a crosslinking agent.

### CROSS-REFERENCE TO RELATED APPLICATION

This application claims priority under 35 USC 119 from Japanese Patent Application No. 2005-278800, the disclosure of which is incorporated by reference herein.

### BACKGROUND OF THE INVENTION

1. Field of the Invention

The present invention relates to an infrared-sensitive planographic printing plate precursor. In particular, the invention relates to an infrared-sensitive planographic printing plate precursor which is excellent in abrasion resistance.

2. Description of the Related Art

Laser technology has been highly developed in recent years, and in particular, with respect to solid lasers and semiconductor lasers which have a light emitting region from near infrared to infrared, high output and small size lasers are readily available. In particular, in the field of planographic printing, as a light source for exposure when a printing plate is made directly from digital data of computers, these lasers are very useful.

A recording layer in a positive-type planographic printing plate precursor for such direct plate-making using an infrared laser contains, as essential components, an alkali-soluble resin, and an infrared absorber which absorbs light and generates heat. In an unexposed area (image area), this infrared absorber acts as a dissolution inhibitor to substantially reduce the solubility of the alkali-soluble resin by interaction with the alkali-soluble resin. In an exposed area (non-image area), the generated heat weakens the interaction between the infrared absorber and the alkali-soluble resin, whereby the resin is dissolved in an alkali developer to form an image. However, in this positive-type planographic printing plate precursor, mechanical strength of the recording layer is not sufficient. As a result, when the recording surface thereof and other members are strongly contacted at the time of manufacturing, transportation or handling, defects are generated on the recording surface, whereby missing portions are generated in the image area after development.

In order to alleviate such a problem, planographic printing plate precursors are usually packaged with interleaving sheets therebetween. However, since interleaving sheets have the problems of 1) increase in cost, and 2) disposal of the interleaving sheets, an “interleaving sheet-less” process using no interleaving sheets is desired. In particular, recently, along with the spread of computer-to-plate (CTP) systems, more and more exposure apparatuses are equipped with a printing plate (precursor) autoloader. Accordingly, in order to avoid problems such as the troublesome work of extracting interleaving sheets manually in advance, and abrasion due to rubbing caused when extracting interleaving sheets in a case where an automatic interleaving sheet extracting mechanism is provided, demand for an interleaving sheet-less process has considerably increased.

As a technique directed to an interleaving sheet-less process, it is known to apply a surface treatment on the back surface of a support so as to alleviate mechanical damage to a photosensitive layer resulting from contact between the photosensitive layer and the back surface of the support.

For example, a recording material for offset printing having a radiation-sensitive layer and an organic polymer-containing back coating layer has been described, which material is provided with a back coating layer containing a pigment such as silica gel and an organic polymer having a glass transition temperature of at least 35° C. and thereby allows stacking without interleaving sheets (Japanese Patent Application Laid-Open (JP-A) No. 2002-46363).

Further, a photosensitive planographic printing plate wherein a coating layer including at least one resin selected from the group consisting of a saturated copolymerized polyester resin, a phenoxy resin, a polyvinyl acetal resin and a vinylidene chloride copolymer resin, having a glass transition temperature of 60° C. or higher, is provided at a side opposite to a photosensitive layer side (for example, see JP-A No. 2005-62456) have been proposed.

However, in the case where an inorganic pigment such as silica gel is contained in a back coating layer, it is found that, when products which have been stacked and packaged without using interleaving sheets are transported, since the hardness of the inorganic pigment is high, abrasion to a photosensitive layer due to rubbing is easily caused.

In recent years, printing with UV-curable ink, which is suitable for card printing and package printing, has been increasing. When UV ink is used to print, in order to clean rollers or printing plates, a cleaning agent that contains a large amount of organic solvent in which various kinds of polymers are readily dissolved is used. When such a cleaning agent is used, it is inevitable that the cleaning agent creeps around to or splashes onto the side opposite to a recording layer side of the printing plate. When previously disclosed organic polymers are used, there are problems in that the organic polymers are dissolved in the cleaning agent, whereby the organic polymers become sticky, thus deteriorating the workability, and adherence of the polymers to the recording layer can easily occur.

For instance, among the resins, PET (polyethylene terephthalate resin) can be dissolved only in special and expensive organic solvents, hence, while PET can avoid such a stickiness problem, it is inappropriate for industrial manufacturing.

When an image of a planographic printing plate is formed with UV ink, in order to impart high printing durability and UV ink printability, after the image is exposed and developed, a burning process, with high temperature processing, is carried out in some cases. However, the respective polymers, being thermoplastic resins, melt during the process and thereby cause problems of contamination of burning processor rolls.

Furthermore, with respect to photosensitive planographic printing plates (precursors) having a back coating layer including an organic polymer such as polyester, it has been found that, when an autoloader for automatically feeding printing plates to a laser exposure apparatus is used without interleaving sheets, abrasion is easily caused of the photosensitive layer due to rubbing, when the autoloader has a structure in which the photosensitive layer and the back surface are pressed against each other.

### SUMMARY OF THE INVENTION

The present invention has been made in view of the above circumstances and provides an infrared-sensitive planographic printing plate precursor.

According to an aspect of the invention, there is provided an infrared-sensitive planographic printing plate precursor comprising: a support; a recording layer on one surface of the support, which recording layer contains a water-insoluble and alkali-soluble resin and an infrared absorber, and is capable of forming an image by infrared irradiation; and an organic polymer layer on the other surface of the support, which organic polymer layer is formed by coating and drying a solution that contains at least one organic polymer selected from epoxy resins and resole resins, and a crosslinking agent.

### DETAILED DESCRIPTION OF THE INVENTION

In the invention, an organic polymer layer is provided on a surface of a support at a side opposite to a side that has a recording layer.

The organic polymer layer comprises at least one organic polymer selected from epoxy resins and resole resins, and can be obtained by coating and drying a coating solution containing at least one organic polymer selected from epoxy resins and resole resins and a crosslinking agent on a surface of a support at a side opposite to a side that has a recording layer.

In the invention, an organic polymer layer is provided on a surface of a support at a side opposite to a side having a recording layer, and the organic polymer layer is formed by coating and drying a coating solution containing at least one organic polymer selected from epoxy resins and resole resins and a crosslinking agent. In this coating process, during heating for drying and thereafter with time, a crosslinking reaction proceeds to form a organic polymer layer having a three-dimensional crosslinking structure. Owing to the high density crosslinking structure, the organic polymer layer is excellent in chemical resistance, particularly in organic solvent resistance. Furthermore, since the polymer used in the invention is a thermosetting resin, the obtained organic polymer layer is excellent in heat resistance and burning resistance.

In what follows, at least one organic polymer selected from epoxy resins and resole resins is called a “particular thermosetting resin” in some cases.

Thus, on the back surface of a support of a planographic printing plate precursor according to the invention, an organic polymer layer that includes a thermosetting resin and is excellent in chemical resistance, organic solvent resistance and heat resistance is present. Accordingly, It is considered that: even after an organic solvent process or a burning process during an image formation, a surface in direct contact with a recording layer tends not to undergo undesirable modification; and, even when the planographic printing plate precursors are stacked without using interleaving sheets, the effect of inhibiting abrasion of a recording layer can be stably maintained over a long period without being affected by environments.

Presence of the epoxy resin and the resole resin in the organic polymer layer can be confirmed according to a standard method by use of infrared absorption spectrometry or mass spectrometry.

According to the invention, infrared-sensitive positive type planographic printing plate precursors can be provided, in which, even when the precursors are stacked without using interleaving sheets, no abrasion of a recording layer is occurred, and which can be readily manufactured and are excellent in chemical resistance, solvent resistance and heat resistance. In addition, since the organic polymer layer on the back surface is excellent in heat resistance, the infrared-sensitive positive type planographic printing plate precursor according to the invention is excellent in burning resistance.

In what follows, respective elements that are included in a planographic printing plate precursor according to the invention will be sequentially described in detail.

[Organic Polymer Layer]

In the invention, on a surface of a support at a side opposite to a side having a recording layer, an organic polymer layer containing the particular thermosetting resin and having a crosslinking structure is provided.

As an epoxy resin, a resole resin and a crosslinking agent that are used to form an organic polymer layer, generally known materials such as shown below can be used.

<Epoxy Resin and Crosslinking Agent Therefor>

As an epoxy resin, condensates of bisphenol A and epichlorohydrin, which have various epoxy equivalents, can be used. Such epoxy resins are commercially available and, for instance, Epicoat 828, Epicoat 1001, Epicoat 1003, Epicoat 1004, Epicoat 1007, Epicoat 1009 and Epicoat 1005F (trade names, manufactured by Japan Epoxy Resin Co., Ltd.) can be exemplified.

Furthermore, condensates of bisphenol F and epichlorohydrin, which have various epoxy equivalents, can also be preferably used and specifically, for instance, Epicoat 4004P and Epicoat 4007P (trade names, manufactured by Japan Epoxy Resin Co., Ltd.) can be exemplified.

Condensates of a mixture of bisphenol A and bisphenol F and epichlorohydrin such as Epicoat 4110 and Epicoat 4210 (trade names, manufactured by Japan Epoxy Resin Co., Ltd.) and condensates of a phenol resin and epichlorohydrin such as Epicoat 152 and Epicoat 154 (trade names, manufactured by Japan Epoxy Resin Co., Ltd.) can also be preferably exemplified.

The epoxy resins may be used alone or in a combination of at least two kinds thereof.

The content of the epoxy resin in the organic polymer layer is, in terms of solid content, preferably in the range of 30 to 99.7% by mass and more preferably in the range of 60 to 98% by mass.

As a crosslinking agent that is used together with the epoxy resin, in general, various compounds that are used to crosslink and cure an epoxy resin can be used.

As the crosslinking agent, for instance, amines such as diethylenetriamine, triethylenetetramine, metaxylenediamine, isophoronediamine and trisdimethylaminomethylphenol; imidazoles such as 1-isobutyl-2-methylimidazole, 1-benzyl-2-methylimidazole and 2-heptaimidazole; acid anhydrides such as phthalic anhydride, hexahydrophthalic anhydride and pyromellitic anhydride; and phenols such as bisphenol A can be exemplified.

The content of the crosslinking agent in the organic polymer layer is, in terms of solid content, preferably in the range of 0.3 to 30% by mass and more preferably in the range of 1 to 20% by mass.

<Resole Resin and Crosslinking Agent Therefor>

As a resole resin that can be used in the invention, any generally used resin that is obtained by condensing a phenol and formalin in the presence of an alkali can be used.

As the phenol that are used to prepare the resole resin, phenolic acid, m-cresol, p-cresol and o-cresol can be preferably used and mixtures thereof can be used as well. In the resole resin, the extent of condensation of the phenol with formalin, the molecular weight and the residual ratio of remaining monomers can be appropriately selected depending on the purpose. Furthermore, those of various grades that have different physical properties are commercially available and can be used in the invention as well.

Examples of the resole resin here include a so-called resole resin precursor that is not yet three-dimensionally crosslinked to form a cured phenol resin.

As commercially available products of the resole resin that can be used in the invention, specifically, for instance, Sumilite Resin PR-9480, Sumilite Resin PR-14170, Sumilite Resin PR-51107, Sumilite Resin PR-51904, Sumilite Resin EM-1, Sumilite Resin PR-EPN, Sumilite Resin PR-UFC-504 (trade names, manufactured by Sumitomo Bakelight Co., Ltd.) can be exemplified.

The resole resins can be used alone or in combination of at least two kinds thereof.

The content of the resole resin in the organic polymer layer is, in terms of solid content, preferably in the range of 30 to 99.7% by mass and more preferably in the range of 60 to 98% by mass.

Examples of the crosslinking agent in the invention include not only a substance that itself takes part in a crosslinking reaction but also a substance that accelerates a crosslinking reaction. As a preferable crosslinking agent that can be used for a resole resin, for instance, organic acids such as paratoluene sulfonic acid, xylene sulfonic acid, oxalic acid, phenyl phosphonic acid and acidic phosphoric acid phenyl ester; and inorganic acids such as phosphoric acid, nitric acid and hydrochloric acid can be exemplified.

Furthermore, as a crosslinking agent, hydroxides of alkaline earth metals such as calcium hydroxide and oxides of alkaline earth metals such as calcium oxide can be used as well.

The content of the crosslinking agent in the organic polymer layer is, in terms of solid content, preferably in the range of 0.3 to 30% by mass and more preferably in the range of 1 to 20% by mass.

[Additive to Organic Polymer Layer]

(Filler)

To epoxy resins or resole resins, generally, various fillers are added. These fillers can also be added to the organic polymer layer according to the invention.

As the filler, for instance, calcium carbonate powder, silica powder, wood powder and pulp can be exemplified.

The content of the filler is, in terms of solid content, preferably in the range of 1 to 50% by mass and more preferably in the range of 5 to 30% by mass.

(Other Organic Polymers)

The organic polymer layer in the invention may contain only the particular thermosetting resin as a polymer component. However, as far as effects of the invention are not impaired, organic polymers other than the particular thermosetting resins such as polystyrene, polyamide, polyurethane, polyurea, an acrylic resin and a polyvinyl acetal resin can be used together. The organic polymers that can be used together are preferably hydrophobic resins from a viewpoint of effects.

The content of other organic polymers that can be used together is preferably 40% by mass or less with respect to the particular thermosetting resins.

(Other Components)

For the purpose of imparting flexibility, adjusting slidability and improving a coating surface state, plasticizers, surfactants and other additives may be added to an organic polymer layer in such an amount that the effect of the invention is not deteriorated.

(Plasticizer)

As the plasticizer, for example, phthalic acid esters such as dimethyl phthalate, diethyl phthalate, dibutyl phthalate, diisobutyl phthalate, dioctyl phthalate, octylcapryl phthalate, dicyclohexyl phthalate, ditridecyl phthalate, butylbenzyl phthalate, diisodecyl phthalate, and diallyl phthalate, glycol esters such as dimethylglycol phthalate, ethylphthalylethyl glycolate, methylphthalylethyl glycolate, butylphthalylbutyl glycolate, and triethylene glycol dicaprylic acid ester, phosphate esters such as tricresyl phosphate, and triphenyl phosphate, aliphatic dibasic acid esters such as diisobutyl adipate, dioctyl adipate, dimethyl sebacate, dibutyl sebacate, dioctyl azelate, and dibutyl maleate, polyglycidyl methacrylate, triethyl citrate, glycerin triacetyl ester, and butyl laurate are effective.

The addition amount of the plasticizer varies depending on the kind of an organic polymer used in an organic polymer layer, and it is preferable that the plasticizer is added in such an amount that a glass transition temperature of the layer is not 60° C. or lower.

(Surfactant)

Examples of the surfactant include anionic, cationic, nonionic and amphoteric surfactants. Specific examples include nonionic surfactants such as polyoxyethylene alkyl ethers, polyoxyethylene alkyl phenyl ethers, polyoxyethylene polystyryl phenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenated castor oils, polyoxyethyleneglycerin fatty acid partial esters, fatty acid diethanolamides, N,N-bis-2-hydroxyalkylamines, polyoxyethylenealkylamine, triethanolamine fatty acid ester, and trialkylamine oxide, anionic surfactants such as fatty acid salts, abietic acid salts, hydroxyalkanesulfonic acid salts, alkanesulfonic acid salts, dialkylsulfosuccinic acid ester salts, straight chain alkylbenzenesulfonic acid salts, branched alkylbenzenesulfonic acid salts, alkylnaphthalenesulfonic acid salts, alkylphenoxypolyoxyethylenepropylsulfonic acid salts, polyoxyethylene alkyl sulfophenyl ether salts, N-methyl N-oleyltaurine sodium salt, N-alkylsulfosuccinic acid monoamide disodium salt, petroleum sulfonic acid salts, sulfated beef tallow oil, sulfate ester salts of fatty acid alkyl ester, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styryl phenyl ether sulfate ester salts, alkylphosphate ester salts, polyoxyethylene alkyl ether phosphate ester salts, polyoxyethylene alkyl phenyl ether phosphate ester salts, partial saponified products of styrene/maleic anhydride copolymer, partial saponified products of olefin/maleic anhydride copolymer, and naphthalenesulfonic acid salt formalin condensates, cationic surfactants such as alkylamine salts, quaternary ammonium salts, polyoxyethylenealkylamine salts, and polyethylenepolyamine derivative, and amphoteric surfactants such as carboxylbetaines, aminocarboxylic acids, sulfobetaines, aminosulfate esters, and imidazolines. Among the above-listed surfactants, polyoxyethylene can be also read as polyoxyalkylene such as polyoxymethylene, polyoxypropylene and polyoxybutylene, and those surfactants are also included.

A further preferable surfactant is a fluorine type surfactant containing a perfluoroalkyl group in a molecule. Examples of the fluorine type surfactant include anion type such as perfluoroalkylcarboxylic acid salt, perfluoroalkylsulfonic acid salt, and perfluoroalkylphosphoric acid ester, amphoteric types such as perfluoroalkylbetaine, cationic types such as perfluoroalkyltrimethylammonium salt, and nonionic types such as perfluoroalkylamine oxide, perfluoroalkylethylene oxide adduct, perfluoroalkyl group and hydrophilic group-containing oligomer, perfluoroalkyl group and oleophilic group-containing oligomer, perfluoroalkyl group, hydrophilic group and oleophilic group-containing oligomer, and perfluoroalkyl group and oleophilic group-containing urethane.

Surfactants may be used alone, or may be used in combination of two or more kinds, and can be added to an organic polymer layer in an amount of preferably 0.001 to 10% by mass, more preferably 0.01 to 5% by mass.

Further, a dye for coloring, a silane coupling agent for improving adherability with an aluminum support, a diazo resin containing a diazonium salt, organic phosphonic acid, organic phosphoric acid and a cationic polymer, and further, a wax which is usually used as a sliding agent, higher fatty acid, higher fatty acid amide, a silicone compound consisting of dimethylsiloxane, modified dimethylsiloxane, and a polyethylene powder may be appropriately added to an organic polymer layer.

The thickness of the organic polymer layer may be such a thickness that a recording layer is not damaged without an interleaving sheet, and normally preferably in the range of 0.3 to 25 μm, more preferably in the range of 0.5 to 15 μm and still more preferably in the range of 1.0 to 20 μm. When the thickness is within the above range, when the planographic printing plate precursors are stacked and handled, rubbing abrasion of the recording layer can be effectively inhibited.

(Formation of Organic Polymer Layer)

An organic polymer layer according to the invention can be formed by preparing a coating solution containing at least one organic polymer selected from epoxy resins and resole resins, a crosslinking agent, and other compounds as required, and coating and drying the coating solution on a surface (back surface) of a support at a side opposite to a side at which a recording layer is formed.

To the coating solution, a solvent is preferably added to improve the handling property.

As a solvent to be used, organic solvents as described in JP-A No. 62-251739 can be used alone, or in combination. Examples of the solvent are not limited to, but include ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone, and toluene. These solvents are used alone, or in combination.

When the organic polymer layer is formed, the coating solution is coated on a surface (back surface) of a support at a side opposite to a side at which a recording layer is formed, followed by drying. During the drying, owing to an action of the crosslinking agent, a high density crosslinking structure is formed in the organic polymer layer, and the thermosetting resin is simultaneously cured. As a result, a film that has high hardness and strength and is excellent not only in abrasion resistance but also in chemical resistance and solvent resistance is formed. The drying conditions are preferably as follows, from a viewpoint of promoting the curing of the thermosetting resin and the forming of the crosslinking structure resulting from a crosslinking agent.

For instance, it is preferable to heat with dry air at 100 to 180° C. for 30 sec to 5 min, and after drying, it is preferable to bring into contact with a metal roll heated to 100 to 180° C. Furthermore, a heating method of irradiating infrared ray may be preferably used.

(Characteristics of Organic Polymer Layer)

From a viewpoint of sufficiently exerting effects of the invention, the dynamic friction coefficient of the surface of the organic polymer layer is preferably in the range of 0.38 to 0.70. When the organic polymer layer is formed, along with taking this point into consideration, the amount of contained resins, the amount of added crosslinking agent and the curing conditions may be determined.

The dynamic friction coefficient here indicates a value measured according to the standard ASTM D1894 (the disclosure of which is incorporated by reference herein) while bringing an organic polymer layer surface and a recording layer surface at a side opposite to the organic polymer layer side into contact with each other.

The infrared-sensitive planographic printing plate precursor of the invention can exert an excellent effect in that, even when the precursors are stacked without using interleaving sheets, at the time of manufacturing, plate-making, conveyance during packaging or transportation after shipping, rubbing abrasion and adhesion problems are not caused on a recording layer, because the precursors have the aforementioned organic polymer layer. That is, for example, even when the planographic printing plate precursors are stacked, packaged and transported, rubbing abrasion to a recording layer, which is caused by rubbing between a surface at a recording layer side and a back surface (a surface having an organic polymer layer) due to vibration during transportation, is not caused. In addition, even when stacked printing plate precursors are stored for a long period of time under high humidity conditions, adhesion problems are not caused on a recording layer. Further, even in a case where a surface at a recording layer side and a back surface of a printing plate precursor are partially strongly pressed while the precursor is moved, as in the case where a light exposure apparatus equipped with an autoloader is used, rubbing abrasion to a recording layer is not caused.

[Recording Layer]

The recording layer according to the invention is a layer which can form an image by infrared irradiation, and may be any of a monolayer and a multi-layered structure. In the case of a monolayer-type recording layer, the recording layer contains a water-insoluble and alkali-soluble resin, and an infrared absorber. In the case of a multi-layered-type recording layer, the recording layer contains a water-insoluble and alkali-soluble resin, and at least one of a layer situated nearest to a support (hereinafter, referred to as “lower layer” in some cases) and/or a layer situated furthest from a support (hereinafter, referred to as “uppermost layer” in some cases) contains an infrared absorber.

(Water-Insoluble and Alkali-Soluble Resin)

A water-insoluble and alkali-soluble resin (hereinafter, referred to as alkali-soluble resin in some cases) used in the recording layer of the invention may be a homopolymer containing an acidic group on a main chain and/or a side chain in a polymer, a copolymer thereof and a mixture thereof. Therefore, the recording layer in the invention is dissolved in an alkaline developer when contacted with the alkaline developer.

An alkali-soluble resin used in the present invention may be a conventionally known resin, and is not particularly limited, but is preferably a polymer compound having at least one acidic group selected from (1) a phenolic hydroxy group, (2) a sulfonamido group, (3) an active imido group, and (4) a carboxylic acid group in a molecule. For example, the following are exemplified, but the resin is not limited to them.

(1) Examples of the polymer compound having a phenolic hydroxy group include novolak resins such as a phenol formaldehyde resin, a m-cresol formaldehyde resin, a p-cresol formaldehyde resin, a m-/p-mixed cresol formaldehyde resin, and a phenol/cresol (any of m-, p- and m-/p-mixed may be used) mixed formaldehyde resin, and a pyrogallol acetone resin.

In addition, as the alkali-soluble resin having a phenolic hydroxy group, a resin obtained by condensing substituted phenols represented by the following formula (i) and aldehydes is a preferable example.

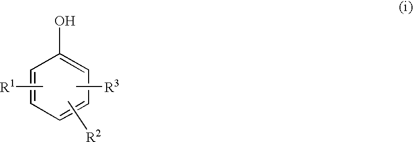

In the formula (i), R¹ and R² each represent a hydrogen atom, an alkyl group or a halogen atom. The alkyl group preferably has 1 to 3 carbon atoms, more preferably has 1 or 2 carbon atoms. The halogen atom is any of a fluorine atom, a chlorine atom, a bromine atom and an iodine atom, preferably a chlorine atom or a bromine atom. And, R³ represents an alkyl group having 3 to 6 carbon atoms, or a cycloalkyl group.

Examples of the substituted phenols include isopropylphenol, t-butylphenol, t-amylphenol, hexylphenol, cyclohexylphenol, 3-methyl-4-chloro-6-tertiarybutylphenol isopropylcresol, t-butylcresol, and t-amylcresol. Inter alia, t-butylphenol and t-butylcresol are preferable.

Examples of aldehydes used for condensing with the substituted phenols include aliphatic and aromatic aldehydes such as formaldehyde, acetoaldehyde, acrolein, and crotonaldehyde. Inter alia, formaldehyde and acetoaldehyde are preferable.

Other examples of the alkali-soluble resin having a phenolic hydroxy group include polymer compounds having a phenolic hydroxy group on a side chain. Examples of the polymer compound having a phenolic hydroxy group on a side chain include polymer compounds obtained by homo-polymerizing a polymerizable monomer consisting of a low-molecular compound having one or more phenolic hydroxy group and one or more polymerizable unsaturated bond, or copolymerizing the monomer with another polymerizable monomer.

Examples of the polymerizable monomer having a phenolic hydroxy group include acrylamide, methacrylamide, acrylic acid ester, methacrylic acid ester and hydroxystyrene which have a phenolic hydroxy group. Specifically, N-(2-hydroxyphenyl)acrylamide, N-(3-hydroxyphenyl)acrylamide, N-(4-hydroxyphenyl)acrylamide, N-(2-hydroxyphenyl)methacrylamide, N-(3-hydroxyphenyl)methacrylamide, N-(4-hydroxyphenyl)methacrylamide, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, o-hydroxystyrene, m-hydroxystyrene, p-hydroxystyrene, 2-(2-hydroxyphenyl)ethyl acrylate, 2-(3-hydroxyphenyl)ethyl acrylate, 2-(4-hydroxyphenyl)ethyl acrylate, 2-(2-hydroxyphenyl)ethyl methacrylate, 2-(3-hydroxyphenyl)ethyl methacrylate, and 2-(4-hydroxyphenyl)ethyl methacrylate can be suitably used. The resin having a phenolic hydroxy group may be used in combination of two or more kinds.

Examples of the alkali-soluble resin having a phenolic hydroxy group used in the invention include an alkali-soluble resin in which at least a part of phenolic hydroxy groups of the alkali-soluble resin having a phenolic hydroxy group is esterified, which is described in JP-A No. 11-288089.

(2) Examples of the alkali-soluble resin having a sulfonamido group include polymer compounds obtained by homo-polymerizing a polymerizable monomer having a sulfonamido group, or copolymerizing the monomer with another copolymerizable monomer. Examples of the polymerizable monomer having a sulfonamido group include a polymerizable monomer consisting of a low-molecular compound having one or more sulfonamido group —NH—SO₂— in which at least one hydrogen atom is bound to a nitrogen atom, and one or more polymerizable unsaturated bond in one molecule. Among them, a low-molecular compound having an acryloyl group, an allyl group or a vinyloxy group, and a substituted or mono-substituted aminosulfonyl group or a substituted sulfonylimino group is preferable.

Examples of the alkali-soluble resin having a sulfonamido group include resins described in Japanese Patent Application Publication (JP-B) No. 7-69605.

(3) As the alkali-soluble resin having an active imido group, a resin having an active imido group (—CO—NH—SO₂—) in a molecule is preferable, and examples of this polymer compound include a polymer compound obtained by homo-polymerizing a polymerizable monomer consisting of a low-molecular compound having one or more active imido group and one or more polymerizable unsaturated bond in one molecule, or copolymerizing the monomer with another polymerizable monomer.

As an example of such a compound, N-(p-toluenesulfonyl)methacrylamide, and N-(p-toluenesulfonyl)acrylamide can be suitably used.

(4) Examples of the alkali-soluble resin having a carboxylic acid group include a polymer compound obtained by homo-polymerizing a polymerizable monomer consisting of a low-molecular compound having one or more carboxylic acid group and one or more polymerizable unsaturated group in a molecule, or copolymerizing the monomer with another copolymerizable monomer. Examples of the polymerizable monomer having a carboxylic acid group include α,β-unsaturated carboxylic acids such as acrylic acid, methacrylic acid, maleic acid, maleic anhydride, and itaconic acid. In addition, an unsaturated carboxylic acid which is a monoester of a hydroxyl group of acrylate or methacrylate having a hydroxyl group on a side chain (e.g. 2-hydroxyethylethyl acrylate or methacrylate etc.) and a dibasic acid (e.g. succinic acid, glutaric acid, phthalic acid etc.) is a preferable example.

Further, as the alkali-soluble resin in the invention, a polymer compound obtained by polymerizing two or more kinds among the polymerizable monomer having a phenolic hydroxy group, the polymerizable monomer having a sulfonamido group, the polymerizable monomer having an active imido group, and the polymerizable monomer having a carboxylic acid group, or a polymer compound obtained by copolymerizing these two or more kinds of polymerizable monomers with another polymerizable monomer can be used.

In the invention, when the alkali-soluble resin is a copolymer of the monomer having an acidic group (a phenolic hydroxy group, a sulfonamido group, an active imido group, a carboxylic acid group) with another polymerizable monomer, from a viewpoint of alkali solubility, a monomer imparting alkali solubility is used at preferably 10 mol % or more, more preferably 20 mol % or more.

Examples of a monomer component to be copolymerized with the monomer having an acidic group are not limited to, but include compounds listed in the following (m1) to (m11).

(m1) Acrylic acid esters and methacrylic acid esters having an aliphatic hydroxy group such as 2-hydroxyethyl acrylate and 2-hydroxyethyl methacrylate.

(m2) Alkyl acrylates such as methyl acrylate, ethyl acrylate, propyl acrylate, butyl acrylate, amyl acrylate, hexyl acrylate, octyl acrylate, benzyl acrylate, 2-chloroethyl acrylate, and glycidyl acrylate.

(m3) Alkyl methacrylate such as methyl methacrylate, ethyl methacrylate, propyl methacrylate, butyl methacrylate, amyl methacrylate, hexylmaethacrylate, cyclohexyl methacrylate, benzyl methacrylate, 2-chloroethyl methacrylate, and glycidyl methacrylate.

(m4) Acrylamides or methacrylamides such as acrylamide, methacrylamide, N-methylolacrylamide, N-ethylacrylamide, N-hexylmethacrylamide, N-cyclohexylacrylamide, N-hydroxyethylacrylamide, N-phenylacrylamide, N-nitrophenylacrylamide, and N-ethyl-N-phenylacrylamide.

(m5) Vinyl ethers such as ethyl vinyl ether, 2-chloroethyl vinyl ether, hydroxyethyl vinyl ether, propyl vinyl ether, butyl vinyl ether, octyl vinyl ether, and phenyl vinyl ether.

(m6) Vinyl esters such as vinyl acetate; vinyl chloroacetate, vinyl butyrate, and vinyl benzoate.

(m7) Styrenes such as styrene, α-methylstyrene, methylstyrene, and chloromethylstyrene.

(m8) Vinyl ketones such as methyl vinyl ketone, ethyl vinyl ketone, propyl vinyl ketone, and phenyl vinyl ketone.

(m9) Olefins such as ethylene, propylene, isobutylene, butadiene, and isoprene.

(m10) N-vinylpyrrolidone, acrylonitrile, and methacrylonitrile.

(m11) Unsaturated imides such as maleimide, N-acryloylacrylamide, N-acetylmethacrylamide, N-propionylmethacrylamide, and N-(p-chlorobenzoyl)methacrylamide.

As a method of copolymerization of the alkaline water-soluble polymer compound, conventionally known methods such as graft copolymerization method, block copolymerization method, and random copolymerization method can be used.

When the alkali-soluble resin is a homopolymer or a copolymer of the polymerizable monomer having an acidic group in the invention, a weight average molecular weight thereof is preferably 2,000 or more, further preferably 5,000 to 300,000. In addition, when the alkali-soluble resin is a resin such as a phenol formaldehyde resin and a cresol aldehyde resin in the invention, a weight average molecular weight thereof is preferably 500 to 50,000, more preferably 700 to 20,000, particularly preferably 1,000 to 10,000.

When a recording layer has a multi-layered structure, as the alkali-soluble resin used in an uppermost layer of the recording layer, a resin having a phenolic hydroxy group is desirable because strong hydrogen bonding property is generated in an unexposed area, and a part of hydrogen bonds is easily eliminated in an exposed area. Further preferable is a novolak resin.

In the invention, two or more kinds of alkali-soluble resins having different dissolution rates in an alkaline aqueous solution may be mixed and used, and a mixing ratio in that case is arbitrary. As a preferable alkali-soluble resin to be mixed with a resin having a phenolic hydroxy group which is suitably used in an uppermost layer of a multi-layered-type recording layer, an acryl resin is preferable, and an acryl resin having a sulfoamido group or a carboxylic acid group is more preferable, since the resin has low compatibility with a resin having a phenolic hydroxy group.

When a recording layer is a multi-layered structure, the aforementioned alkali-soluble resin is used in a lower layer of the recording layer, and it is required that a lower layer itself shows high alkali solubility, particularly in a non-image area. In addition, it is also required that resistance to various printing chemicals is shown at the time of printing, and stable printing durability is shown under various printing conditions. For this reason, a resin which does not deteriorate these properties is preferably selected. From this viewpoint, it is preferable to select a resin excellent in solubility in an alkali developer, dissolution resistance to various printing chemicals, and physical strength. In addition, it is preferable to select a resin having low solvent solubility which is not dissolved by a coating solvent when coating an uppermost layer thereon, as an alkali-soluble resin used in a lower layer. By selecting such a resin, undesired compatibility at an interface between two layers is suppressed.

From these viewpoints, as an alkali-soluble resin contained in a lower layer, an acryl resin is preferable among the aforementioned alkali-soluble resins. Inter alia, an acryl resin having a sulfonamido group is preferable.

In addition, from the aforementioned viewpoint, as an alkali-soluble resin used in a lower layer, in addition to the aforementioned resins, examples include a polyamide resin, an epoxy resin, a polyvinyl acetal resin, a styrene type resin, and a urethane resin, which are water-insoluble and alkali-soluble. Among them, a urethane resin, and a polyvinyl acetal resin are preferable.

The alkali-soluble resins used in a lower layer may be used alone, or in combination of two or more kinds.

In the case of a monolayer-type recording layer, a content of the alkali-soluble resin based on the total solid content of the recording layer is preferably 30 to 99% by mass, more preferably 40 to 95% by mass from a viewpoint of sensitivity and durability of a recording layer.

In the case of a multi-layered-type recording layer, a content of the alkali-soluble resin based on the total solid content of the uppermost layer is preferably 40 to 98% by mass, more preferably 60 to 97% by mass from a viewpoint of sensitivity and durability of a recording layer.

A content of the alkali-soluble resin in lower layer components is preferably 40 to 95% by mass, more preferably 50 to 90% by mass in the total solid content of the lower layer.

(Development Inhibitor)

A development inhibitor may be contained in a recording layer for the purpose of enhancing its inhibition (dissolution inhibiting ability). When a recording layer has a multi-layered structure, in particular, it is preferable that a development inhibitor is contained in an uppermost layer.

The development inhibitor is not particularly limited as far as it forms interaction with the alkali-soluble resin, substantially reduces solubility of the alkali-soluble resin in a developer in an unexposed area, and has weakened interaction in an exposed area to be soluble in a developer, but in particular, a quaternary ammonium salt, and a polyethylene glycol type compound are preferably used. Some of light-heat converting agents and image coloring agents described later function as a development inhibitor, and they are also preferable examples.

Examples of the quaternary ammonium salt are not particularly limited, but include a tetraalkyl ammonium salt, a trialkylarylammonium salt, a dialkyldiarylammonium salt, an alkyltriarylammonium salt, a tetraarylammonium salt, a cyclic ammonium salt, and a dicyclic ammonium salt.

Specific examples include tetrabutylammonium bromide, tetrapentylammonium bromide, tetrahexylammonium bromide, tetraoctylammonium bromide, tetralaurylammonium bromide, tetraphenylammonium bromide, tetranaphthylammonium bromide, tetrabutylammonium chloride, tetrabutylammonium iodide, tetrastearylammonium bromide, lauryltrimethylammonium bromide, stearyltrimethylammonium bromide, behenyltrimethylammonium bromide, lauryltriethylammonium bromide, phenyltrimethylammonium bromide, 3-trifluoromethylphenyltrimethylammonium bromide, benzyltrimethylammonium bromide, dibenzyldimethylammonium bromide, distearyldimethylammonium bromide, tristearylmethylammonium bromide, benzyltriethylammonium bromide, hydroxyphenyltrimethylammonium bromide, and N-methylpyridinium bromide. In particular, quaternary ammonium salts described in Japanese Patent Application Nos. 2001-226297, 2001-370059 and 2001-398047 are preferable.

From a viewpoint of development inhibiting effect and film making property of the alkali-soluble resin, an addition amount of the quaternary ammonium salt, in the case of a monolayer-type recording layer, is preferably 0.1 to 50% by mass, more preferably 1 to 30% by mass based on the total solid content of the recording layer. In the case of a multi-layered-type recording layer, the addition amount is preferably 0.1 to 50% by mass, more preferably 1 to 30% by mass based on the total solid content of the uppermost layer.

The polyethylene glycol compound is not particularly limited, but examples include compounds of a structure represented by the following formula (vi).
R⁶—O{—O(R⁶³—O—)ₘ—R⁶²}ₙ Formula (vi)

In the formula (vi), R⁶¹ represents a polyhydric alcohol residue or a polyhydric phenol residue, and R⁶² represents a hydrogen atom, or an alkyl group, an alkenyl group, an alkynyl group, an alkyloyl group, an aryl group or an aryloyl group each having 1 to 25 carbon atoms and optionally having a substituent. R⁶³ represents an alkylene residue optionally having a substituent, m represents an integer of 10 or more on average, and n represents an integer of 1 to 4.

Examples of the polyethylene glycol compound represented by the formula (vi) include polyethylene glycols, polypropylene glycols, polyethylene glycol alkyl ethers, polypropylene glycol alkyl ethers, polyethylene glycol aryl ethers, polypropylene glycol aryl ethers, polyethylene glycol alkylaryl ethers, polypropylene glycol alkylaryl ethers, polyethylene glycol glycerin esters, polypropylene glycol glycerin esters, polyethylene sorbitol esters, polypropylene glycol sorbitol esters, polyethylene glycol fatty acid esters, polypropylene glycol fatty acid esters, polyethylene glycolated ethylenediamines, polypropylene glycolated ethylenediamines, polyethylene glycolated diethylenetriamines, and polypropylene glycolated diethylene triamines.

Specific examples include polyethylene glycol 1000, polyethylene glycol 2000, polyethylene glycol 4000, polyethylene glycol 10000, polyethylene glycol 20000, polyethylene glycol 5000, polyethylene glycol 100000, polyethylene glycol 200000, polyethylene glycol 500000, polypropylene glycol 1500, polypropylene glycol 3000, polypropylene glycol 4000, polyethylene glycol methyl ether, polyethylene glycol ethyl ether, polyethylene glycol phenyl ether, polyethylene glycol dimethyl ether, polyethylene glycol diethyl ether, polyethylene glycol diphenyl ether, polyethylene glycol lauryl ether, polyethylene glycol dilauryl ether, polyethylene glycol nonyl ether, polyethylene glycol cetyl ether, polyethylene glycol stearyl ether, polyethylene glycol distearyl ether, polyethylene glycol behenyl ether, polyethylene glycol dibehenyl ether, polypropylene glycol methyl ether, polypropylene glycol ethyl ether, polypropylene glycol phenyl ether, polypropylene glycol dimethyl ether, polypropylene glycol diethyl ether, polypropylene glycol diphenyl ether, polypropylene glycol lauryl ether, polypropylene glycol dilauryl ether, polypropylene glycol nonyl ether, polyethylene glycol acetyl ester, polyethylene glycol diacetyl ester, polyethylene glycol benzoic acid ester, polyethylene glycol lauryl ester, polyethylene glycol dilauryl ester, polyethylene glycol nonylic acid ester, polyethylene glycol cetylic acid ester, polyethylene glycol stearoyl ester, polyethylene glycol distearoyl ester, polyethylene glycol behenic acid ester, polyethylene glycol dibehenic acid ester, polypropylene glycol acetyl ester, polypropylene glycol diacetyl ester, polypropylene glycol benzoic acid ester, polypropylene glycol dibenzoic acid ester, polypropylene glycol lauric acid ester, polypropylene glycol lauric acid ester, polypropylene glycol nonylic acid ester, polyethylene glycol glycerin ether, polypropylene glycol glycerin ether, polyethylene glycol sorbitol ether, polypropylene glycol sorbitol ether, polyethylene glycolated ethylenediamine, polypropylene glycolated ethylenediamine, polyethylene glycolated diethylenetriamine, polypropylene glycolated diethylenetriamine, and polyethylene glycolated pentamethylene hexamine.

From a viewpoint of development inhibiting effect and image forming property, an addition amount of the polyethylene glycol type compound, in the case of a monolayer-type recording layer, is preferably 0.1 to 50% by mass, more preferably 1 to 30% by mass based on the total solid content of the recording layer. In the case of a multi-layered-type recording layer, the addition amount is preferably 0.1 to 50% by mass, more preferably 1 to 30% by mass based on the total solid content of the uppermost layer.

When such a method for enhancing inhibition (dissolution inhibiting ability) is performed, sensitivity is reduced. In this case, addition of a lactone compound described in JP-A No. 2002-361066 to an uppermost layer is effective for inhibiting reduction in sensitivity.

It is preferable that the dissolution inhibiting agent is used together with a thermally degradable substance which substantially reduces solubility of the alkali-soluble resin when not degraded, such as an onium salt, an o-quinonediazide compound, an aromatic sulfone compound and an aromatic sulfonic acid ester compound, because inhibition of an image area in a developer is improved.

Examples of the onium salt used in the invention include a diazonium salt, an ammonium salt, a phosphonium salt, an iodonium salt, a sulfonium salt, a selenonium salt, and arsonium salt, and particularly preferable examples include diazonium salts described in S. I. Schlesinger, Photogr. Sci. Eng., 18, 387 (1974), T. S. Bale et al., Polymer, 21, 423 (1980), and JP-A No. 5-158230, ammonium salts described in U.S. Pat. Nos. 4,069,055, and 4,069,056, and JP-A No. 3-140140, phosphonium salts described in D. C. Necker et al., Macromolecules, 17, 2468 (1984), C. S. Wen et al., The, Proc. Conf. Rad. Curing ASIA, p 478 Tokyo, October (1988), U.S. Pat. Nos. 4,069,055, and 4,069,056, iodonium salts described in J. V. Crivello et al., Macromolecules, 10 (6), 1307 (1977), Chem. & Eng. News, Nov. 28, p 31 (1988), EP 104,143, U.S. Pat. Nos. 5,041,358, and 4,491,628, JP-A No. 2-150848, and JP-A No. 2-296514, sulfonium salts described in J. V. Crivello et al., Polymer J. 17, 73 (1985), J. V. Crivello et al., J. Org. Chem., 43, 3055 (1978), W. R. Watt et al., J. Polymer Sci., Polymer Chem. Ed., 22, 1789 (1984), J. V Crivello et al., Polymer Bull., 14, 279 (1985), J. V Crivello et al., Macromolecules, 14 (5), 1141 (1981), J. V Crivello et al., J. Polymer Sci., Polymer Chem. Ed., 17, 2877 (1979), EP Nos. 370,693, 233,567, 297,443, and 297,442, U.S. Pat. Nos. 4,933,377, 3,902,114, 4,491,628, 4,760,013, 4,734,444, and 2,833,827, German Patent Nos. 2,904,626, 3,604,580 and 3,604,581, selenonium salts described in J. V Crivello et al., Macromolecules, 10 (6), 1307 (1977), J. V Crivello et al., J. Polymer Sci., Polymer Chem. Ed., 17, 1047 (1979), and arsonium salts described in C. S. Wen et al., The, Proc. Conf. Rad. Curing ASIA, p478 Tokyo, October (1988).

Among such onium salts, a diazonium salt is particularly preferable. Particularly preferable examples of a diazonium salt include those described in JP-A No. 5-158230.

Examples of a counterion of an onium salt include anions from tetrafluoroboric acid, hexafluorophosphoric acid, triisopropylnaphthalenesulfonic acid, 5-nitro-o-toluenesulfonic acid, 5-sulfosalicylic acid, 2,5-dimethylbenzenesulfonic acid, 2,4,6-trimethylbenzenesulfonic acid, 2-nitrobenzenesulfonic acid, 3-chlorobenzenesulfonic acid, 3-bromobenzenesulfonic acid, 2-fluorocaprylnaphthalenesulfonic acid, dodecylbenzenesulfonic acid, 1-naphthol-5-sulfonic acid, 2-methoxy-4-hydroxy-5-benzoyl-benzenesulfonic acid and paratoluenesulfonic acid. Among them, in particular, anions from hexafluorophosphoric acid and alkyl aromatic sulfonic acid such as triisopropylnaphthalenesulfonic acid and 2,5-dimethylbenzenesulfonic acid are preferable.

Preferable examples of quinonediazides include an o-quinonediazide compound. The o-quinonediazide compound used in the invention is a compound which has at least one o-quinonediazido group and is thermally degraded to increase alkali solubility, and compounds of various structures can be used. That is, the o-quinonediazide assists solubility of an uppermost layer due to both the effects of loss of inhibition as a development inhibitor and change of the o-quinonediazide itself into an alkali-soluble substance when thermally degraded.

As such an o-quinonediazide compound, compounds described, for example, in J. Coser “Light-Sensitive Systems” (John Wiley & Sons. Inc.), p 339-352 can be used, and in particular, sulfonic acid ester or sulfonic acid amide of o-quinonediazide obtained by reacting with various aromatic polyhydroxy compounds or aromatic amino compounds are suitable. In addition, an ester of benzoquinone(1,2)-diazidosulfonic acid chloride or naphthoquinone-(1,2)-diazido-5-sulfonic acid chloride and pyrogallol-acetone resin described in JP-B No. 43-28403, and an ester of benzoquinone-(1,2)-diazidosulfonic acid chloride or naphthoquinone-(1,2)-diazido-5-sulfonic acid chloride and a phenol-formaldehyde resin described in U.S. Pat. Nos. 3,046,120 and 3,188,210 are suitably used.

Further, an ester of naphthoquinone-(1,2)-diazido-4-sulfonic acid chloride and a phenol formaldehyde resin or a cresol-formaldehyde resin, and an ester of naphthoquinone-(1,2)-diazido-4-sulfonic acid chloride and a pyrogallol-acetone resin are similarly preferably used. Other useful o-quinonediazide compounds are reported in many patents and are known. Examples include those described in JP-A No. 47-5303, JP-A No. 48-63802, JP-ANo. 48-63803, JP-ANo. 48-96575, JP-ANo. 49-38701, JP-ANo. 48-13354, JP-B No. 41-11222, JP-B No. 45-9610, JP-B No. 49-17481, U.S. Pat. Nos. 2,797,213, 3,454,400, 3,544,323, 3,573,917, 3,674,495, and 3,785,825, British Patent Nos. 1,227,602, 1,251,345, 1,267,005, 1,329,888, and 1,330,932, and German Patent No. 854,890.

An addition amount of the o-quinonediazide compound, in the case of a monolayer-type recording layer, is preferably 1 to 50% by mass, more preferably in a range of 5 to 30% by mass based on the total solid content of the recording layer. In the case of a multi-layered-type recording layer, the amount is preferably in a range of 1 to 50% by mass, further preferably 5 to 30% by mass, particularly preferably 10 to 30% by mass based on the total solid content of the uppermost layer. These compounds can be used alone, or may be used as a mixture of a few kinds of them.

In addition, for the purpose of enhancing inhibition of a recording layer surface as well as enhancing resistance to abrasion on a surface, it is preferable to additionally use a polymer prepared from a (meth)acrylate monomer having two or more perfluoroalkyl groups having 3 to 20 carbon atoms in a molecule as a polymerization component, as described in JP-A No. 2000-187318.

An addition amount thereof, in the case of a monolayer-type recording layer, is preferably 0.1 to 10% by mass, more preferably 0.5 to 5% by mass based on the total solid content of the recording layer. In the case of a multi-layered-type recording layer, the amount is preferably 0.1 to 10% by mass, more preferably 0.5 to 5% by mass based on the total solid content of the uppermost layer.

(Infrared Absorber)

The recording layer in the invention contains an infrared absorber.

The planographic printing plate precursor of the invention contains an infrared absorber which has maximum absorption in an infrared region and has light-heat converting ability, thus allowing recording by an infrared laser.

The infrared absorber used in the invention is not particularly limited, as far as it is a dye which absorbs infrared light or near infrared light and generates heat, and various dyes known as an infrared absorber can be used.

When a recording layer in the invention has a multi-layered structure, at least one of a layer situated nearest to a support (a lower layer) and/or a layer situated furthest from a support (an uppermost layer) is a layer containing an infrared absorber, and it is preferable to add an infrared absorber to both of a lower layer and an uppermost layer.

As the infrared absorber, commercially available dyes, and the known dyes described in the literature (e.g. “Dye Handbook”, edited by Organic Synthesis Chemistry Association, published in 1970) can be utilized. Specific examples include dyes such as an azo dye, a metal complex salt azo dye, a pyrazoloneazo dye, an anthraquinone dye, a phthalocyanine dye, a carbonium dye, a quinoneimine dye, a methine dye, and a cyanine dye. In the invention, among these dyes, those absorbing infrared light or near infrared light are particularly preferable since they are suitable for use with lasers emitting infrared light or near infrared light.

Examples of preferable dyes include cyanine dyes described in JP-A No. 58-125246, JP-A No. 59-84356, JP-A No. 60-78787, and U.S. Pat. No. 4,973,572, methine dyes described in JP-A No. 58-173696, JP-A No. 58-181690, and JP-A No. 58-194595, naphthoquinone dyes described in JP-A No. 58-112793, JP-A No. 58-224793, JP-A No. 59-48187, JP-A No. 59-73996, JP-A No. 60-52940, and JP-A No. 60-63744, squarylium dyes described in JP-A No. 58-112792, and cyanine dyes described in British Patent No. 434,875.

As the dye, a near infrared absorbing sensitizers described in U.S. Pat. No. 5,156,938 are also suitably used, and substituted arylbenzo(thio)pyrylium salts described in U.S. Pat. No. 3,881,924, trimethinethiapyrylium salts described in JP-A No. 57-142645 (U.S. Pat. No. 4,327,169), Pyrylium compounds described in JP-ANos. 58-181051, 58-220143, 59-41363, 59-84248, 59-84249, 59-146063, and 59-146061, cyanine dyes described in JP-A No. 59-216146, pentamethinethiopyrylium salts described in U.S. Pat. No. 4,283,475, and pyrylium compounds disclosed in JP-B Nos. 5-13514, and 5-19702 and, as a commercially available dye, Epolight III-178, Epolight III-130, and Epolight III-125 manufactured by Epolin are particularly preferably used.

Another example which is particularly preferable as a dye includes near infrared absorbing dyes described in U.S. Pat. No. 4,756,993 as the formulas (I) and (II).

Among these dyes, particularly preferable examples include cyanine dyes, squarylium dyes, pyrylium salts, nickel thiolate complexes, and indolenine cyanine dyes. Cyanine dyes and indolenine cyanine dyes are further preferable, and one particularly preferable example is a cyanine dye represented by the following formula (a).

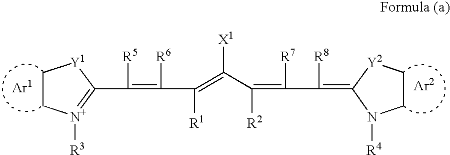

In the formula (a), X¹ represents a hydrogen atom, a halogen atom, —NPh₂, X²-L¹ or a group shown later, wherein X² represents an oxygen atom, a nitrogen atom or a sulfur atom, and L¹ represents a hydrocarbon group having 1 to 12 carbon atoms, an aromatic ring having a heteroatom, or a hydrocarbon group having 1 to 12 carbon atoms containing a heteroatom. Herein, a heteroatom represents N, S, O, a halogen atom or Se. W¹⁻ is as defined for Xa⁻ described later, and R^{a} represents a substituent selected from a hydrogen atom, an alkyl group, an aryl group, a substituted or unsubstituted amino group, and a halogen atom.

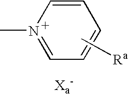

In the formula (a), R¹ and R² each represent independently a hydrocarbon group having 1 to 12 carbon atoms. From a viewpoint of storage stability of a recording layer coating solution, R¹ and R² are preferably a hydrocarbon group having 2 or more carbon atoms, and R¹ and R² are further preferably bonded together to form a 5-membered ring or a 6-membered ring.

Ar¹ and Ar² may be the same or different, and represent an aromatic hydrocarbon group optionally having a substituent. Examples of a preferable aromatic hydrocarbon group include a benzene ring and a naphthalene ring. Examples of a preferable substituent include a hydrocarbon group having 12 or less carbon atoms, a halogen atom, and an alkoxy group having 12 or less carbon atoms. Y¹ and Y² may be the same or different, and represent a sulfur atom or dialkylmethylene group having 12 or less carbon atoms. R³ and R⁴ may be the same or different, and represent a hydrocarbon group having 20 or less carbon atoms and optionally having a substituent. Examples of a preferable substituent include an alkoxy group having 12 or less carbon atoms, a carboxyl group, and a sulfo group. R⁵, R⁶, R⁷ and R⁸ may be the same or different, and represent a hydrogen atom or a hydrocarbon group having 12 or less carbon atoms. From availability of a raw material, they are preferably a hydrogen atom. Xa⁻ represents a counteranion, but when a cyanine dye represented by the formula (a) has an anionic substituent in its structure, and neutralization of a charge is not necessary, W¹⁻ is not necessary. From a viewpoint of storage stability of a recording layer coating solution, preferable Xa⁻ is a halogen ion, a perchlorate ion, a tetrafluoroborate ion, a hexafluorophosphate ion, and a sulfonate ion, particularly preferably a perchlorate ion, a hexafluorophosphate ion, and an arylsulphonate ion.

In the case of a multi-layered-type recording layer, from a viewpoint of sensitivity, it is preferable that an infrared absorber is added to an uppermost layer of a recording layer or a vicinity thereof. In particular, when a component having dissolution inhibiting ability such as a cyanine dye together with an alkali-soluble resin having a phenol group is added, high sensitivity of the recording layer can be obtained, and at the same time, an unexposed area can be endowed with alkali dissolution resistance. Alternatively, the infrared absorber may be added to a lower layer, or may be added to both of an uppermost layer and a lower layer. By adding to a lower layer, further higher sensitivity is obtained. When an infrared absorber is added to both of an uppermost layer and a lower layer, same infrared absorber may be added to each layer or different infrared absorber may be added to each layer.

Alternatively, a layer other than a recording layer is provided, and the infrared absorber may be added to the layer. When another layer is provided, it is desirable to add the infrared absorber to a layer adjacent to a recording layer.

In the case of a monolayer-type recording layer, an addition amount of the infrared absorber is preferably 3 to 50% by mass, further preferably 5 to 40% by mass based on the total solid content of the recording layer. In the case of a multi-layered-type recording layer, when the absorber is added to an uppermost layer of a recording layer, the amount is 0.01 to 50% by mass, preferably 0.1 to 30% by mass, particularly preferably 1.0 to 30% by mass based on the total solid content of the uppermost layer. When the addition amount is in the above range, sensitivity and durability of a recording layer become excellent. On the other hand, when the absorber is added to a lower layer, the absorber can be added in an amount of 0 to 20% by mass, preferably 0 to 10% by mass; particularly preferably 0 to 5% by mass, based on the total solid content of the lower layer.

In the case where the infrared absorber is added to a lower layer, when the infrared absorber having dissolution inhibiting ability is used, solubility of a lower layer is reduced, but on the other hand, the infrared absorber generates heat at the time of infrared laser exposure, and improvement in solubility of a lower layer due to heat is expected. Accordingly, compounds to be added and an addition amount thereof should be selected in view of balance therebetween. At a region around 0.2 to 0.3 μm from a support surface, heat generated at the time of exposure is diffused into the support, the effect of improving solubility due to heat is hardly obtained, and reduction in solubility of a lower layer due to addition of the infrared absorber becomes a cause for reduction in sensitivity in some cases. Therefore, within the range of an addition amount shown above, such an addition amount that a dissolution rate of a lower layer in a developer (25 to 30° C.) is below 30 nm/sec is not preferable.

(Other Additives)

At the time of formation of a recording layer, in addition to the aforementioned components, various additives may be further added as necessary, as far as the effect of the invention is not deteriorated.

In the case of a multi-layered-type recording layer, the following additives may be added to only a lower layer of a recording layer, may be added to only an uppermost layer, or may be added to both layers.

<Development Accelerator>

For the purpose of improving sensitivity, acid anhydrides, phenols and organic acids may be added to a recording layer.

As acid anhydrides, a cyclic acid anhydride is preferable, and specifically as the cyclic acid anhydride, phthalic anhydride, tetrahydrophthalic anhydride, hexahydrophthalic anhydride, 3,6-endoxy-tetrahydrophthalic anhydride, tetrachlorophthalic anhydride, maleic anhydride, chloromaleic anhydride, a-phenylmaleic anhydride, succinic anhydride, and pyromellitic anhydride each described in U.S. Pat. No. 4,115,128 can be used. Examples of a non-cyclic acid anhydride include acetic anhydride.

Examples of phenols include bisphenol A, 2,2′-bishydroxysulfone, 4,4′-bishydroxysulfone, p-nitrophenol, p-ethoxyphenol, 2,4,4′-trihydroxybenzophenone, 2,3,4-trihydroxybenzophenone, 4-hydroxybenzophenone, 4,4′-4″-trihydroxytriphenylmethane, and 4,4′,3″,4″-tetrahydroxy-3,5,3′,5′-tetramethyltriphenylmethane.

Examples of organic acids include sulfonic acids, sulfinic acids, alkylsulfuric acids, phosphonic acids, phosphoric acid esters and carboxylic acids each described in JP-A No. 60-88942, and JP-A No. 2-96755, and specific examples include p-toluenesulfonic acid, dodecylbenzenesulfonic acid, p-toluenesulfinic acid, ethylsulfuric acid, phenylphosphonic acid, phenylphosphinic acid, phenyl phosphate, diphenyl phosphate, benzoic acid, isophthalic acid, adipic acid, p-toluic acid, 3,4-dimethoxybenzoic acid, phtalic acid, terephthalic acid, 4-cyclohexene-1,2-dicarboxylic acid, erucic acid, lauric acid, n-undecanoic acid, and ascorbic acid.

In the case of a monolayer-type recording layer, a ratio of acid anhydrides, phenols or organic acids contained in the total solid content of the recording layer is preferably 0.05 to 20% by mass, more preferably 0.1 to 15% by mass, particularly preferably 0.1 to 10% by mass. In the case of a multi-layered-type recording layer, a ratio of acid anhydrides, phenols or organic acids contained in the total solid content of the lower layer of the recording layer or the uppermost layer is preferably 0.05 to 20% by mass, more preferable 0.1 to 15% by mass, particularly preferably 0.1 to 10% by mass, respectively.

<Surfactant>

In order to improve coatability and stability of treatment in developing condition, nonionic surfactants described in JP-A No. 62-251740 and JP-A No. 3-208514, amphoteric surfactants described in JP-A No. 59-121044 and JP-A No. 4-13149, siloxane compounds described in European Patent No. 950517, and copolymers of a fluorine-containing monomer described in JP-A No. 62-170950, JP-A No. 11-288093, and JP-A No. 2003-057820 can be added to a recording layer.

In the case of a monolayer-type recording layer, a ratio of a surfactant contained in the total solid content of the recording layer is preferably 0.01 to 15% by mass, more preferably 0.1 to 5% by mass, particularly preferably 0.05 to 0.5% by mass.

In the case of a multi-layered-type recording layer, a ratio of a surfactant contained in the total solid content of the lower layer of the recording layer or the uppermost layer is preferably 0.01 to 15% by mass, more preferably 0.1 to 5.0% by mass, further preferably 0.05 to 2.0% by mass.

<Printing-Out Agent/Coloring Agent>

A printing-out agent for obtaining a visualized image immediately after heating by exposure, and a dye and a pigment as an image coloring agent can be added to a recording layer.

Typical examples of the printing-out agent include a combination of an organic dye which can form a salt with a compound releasing an acid when heated by exposure to light (photo acid releasing agent). Specific examples include a combination of o-naphthoquinonediazido-4-sulfonic acid halogenide and a salt forming organic dye described in JP-A Nos. 50-36209 and 53-8128, and a combination of a trihalomethyl compound and a salt forming organic dye described in JP-A Nos. 53-36223, 54-74728, 60-3626, 61-143748, 61-151644 and 63-58440. As such a trihalomethyl compound, there are an oxazole compound and a triazine compound, and both compounds are excellent in stability with time, and give a clear printed out image.

As the image coloring agent, in addition to the aforementioned salt forming organic dye, other dyes can be used. Examples of preferable dyes including the salt forming organic dye include oil-soluble dyes and basic dyes. Specific examples include Oil Yellow #101, Oil Yellow #103, Oil Pink #312, Oil Green BQ Oil Blue BOS, Oil Blue #603, Oil Black BY, Oil Black BS, Oil Black T-505 (all manufactured by Orient Chemical Industries, Ltd.), Victoria Pure Blue, Crystal Violet Lactone, Crystal Violet (CI42555), Methyl Violet (CI42535), Ethyl Violet, rhodamine B (CI145170 B), Malachite Green (CI42000), and Methylene Blue (CI52015). In addition, dyes described in JP-A No. 62-293247 are particularly preferable.

In the case of a monolayer-type recording layer, these dyes can be added at a ratio of 0.01 to 10% by mass, preferably 0.1 to 3% by mass based on the total solid content of the recording layer.

In the case of a multi-layered-type recording layer, those dyes can be added at a ratio of 0.01 to 10% by mass, preferably 0.1 to 3% by mass based on the total solid content of the lower layer of the recording layer or the uppermost layer.

<Plasticizer>

A plasticizer may be added to a recording layer in order to impart softness to a coated film. For example, butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate, and an oligomer and a polymer of acrylic acid or methacrylic acid are used.

In the case of a monolayer-type recording layer, these plasticizers can be added at a ratio of 0.5 to 10% by mass, preferably 1.0 to 5.0% by mass based on the total solid content of the recording layer.

In the case of a recording layer of a multi-layered structure, they can be added at a ratio of 0.5 to 10% by mass, preferably 1.0 to 5.0% by mass based on the total solid content of the lower layer of the recording layer or the uppermost layer.

<WAX Agent>

For the purpose of imparting resistance to abrasion, a compound which reduces a static friction coefficient of a surface may be added to a monolayer-type recording layer or an uppermost layer of a multi-layered-type recording layer according to the invention. Specific examples include compounds having an ester of long-chain alkylcarboxylic acid described in U.S. Pat. No. 6,117,913, and those compounds described in Japanese Patent Application Nos. 2001-261627 and 2002-032904 and Japanese Patent Application No. 2002-165584 which were previously proposed by the present applicant.

As an addition amount, in the case of a monolayer-type recording layer, the agent can be added at a ratio of 0.1 to 10% by mass, preferably 0.5 to 5.0% by mass based on the total solid content of the recording layer.

In the case of a recording layer of a multi-layered structure, a ratio of the agent in an uppermost layer of a recording layer is preferably 0.1 to 10% by mass, more preferably 0.5 to 5% by mass.

(Formation of a Recording Layer)

A recording layer in the planographic printing plate precursor of the invention can be formed by dissolving respective components constituting a recording layer in a solvent, and coating the solution.

Examples of the solvent used herein are not limited to, but include ethylene dichloride, cyclohexanone, methyl ethyl ketone, methanol, ethanol, propanol, ethylene glycol monomethyl ether, 1-methoxy-2-propnaol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone, and toluene. These solvents are used alone, or in combination.

In the case of a multi-layered-type recording layer, it is preferable that a lower layer and an uppermost layer of a recording layer are formed, in principle, so as to separate the two layers.

Examples of a method of forming two layers so as to separate them include a method utilizing a difference in solvent solubility between components contained in a lower layer and components contained in an uppermost layer, and a method of coating an uppermost layer, and rapidly drying and removing a solvent.

Details of these methods are described in JP-A No. 2002-251003.

In order to impart new function, partial compatibilization between an uppermost layer and a lower layer is positively performed in some cases in such a range that the effect of the invention is sufficiently exerted. In this case, partial compatibilization becomes possible by controlling a difference in solvent solubility, and a rate of drying a solvent after coating an uppermost layer.

A concentration of the aforementioned components except for a solvent (a total solid content containing additives) in a coating solution for a recording layer which is to be coated on a support is preferably 1 to 50% by mass.

As a coating method, various methods can be used, and examples include a bar coater coating, rotation coating, spray coating, curtain coating, dip coating, air knife coating, blade coating, and roll coating.

In particular, in the case of a multi-layered type recording layer, in order to prevent damage on a lower layer at the time of coating an uppermost layer, it is desirable that an uppermost layer coating method is non-contact manner. As a method which is generally used for coating in a solvent system but is a contact type method, it is also possible to use bar coater coating, but in order to prevent damage on a lower layer, it is desirable to perform coating by forward rotation driving.

In the case of a monolayer-type recording layer, a coating amount after drying of a recording layer is preferably in a range of 0.3 to 3.0 g/m², further preferably in a range of 0.5 to 2.5 g/m².

In the case of a multi-layered type recording layer, a coating amount after drying of a lower layer component is preferably in a range of 0.5 to 4.0 g/m², further preferably in a range of 0.6 to 2.5 g/m². When the amount is 0.5 g/m² or more, printing durability is excellent, and when the amount is 4.0 g/m² or less, excellent image reproducibility and sensitivity are obtained.

A coating amount after drying of an uppermost layer component is preferably in a range of 0.05 to 1.0 g/m², further preferably in a range of 0.08 to 0.7 g/m². When the amount is 0.05 g/m² or more, excellent development latitude and abrasion resistance are obtained, and when the amount is 1.0 g/m² or less, excellent sensitivity is obtained.

A total coating amount after drying of a lower layer and an uppermost layer is preferably in a range of 0.6 to 4.0 g/m², further preferably in a range of 0.7 to 2.5 g/m². When the amount is 0.6 g/m² or more, excellent printing durability is obtained, and when the amount is 4.0 g/m² or less, excellent image reproducibility and sensitivity are obtained.

[Support]

A support used in the planographic printing plate precursor of the invention is not particularly limited as far as it is a dimensionally stable plate having necessary strength and durability, and examples include a paper, a paper laminated with a plastic (e.g. polyethylene, polypropylene, polystyrene etc.), a metal plate (e.g. aluminum, zinc, copper etc.), a plastic film (e.g. cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal etc.), and a paper or plastic film onto which the metal is laminated or deposited.

Inter alia, in the invention, a polyester film and an aluminum plate are preferable, and among them, an aluminum plate, which is dimensionally stable and is relatively inexpensive, is particularly preferable. A preferable aluminum plate is a pure aluminum plate and an alloy plate containing aluminum as a main component and containing a trace amount of different elements, and further, a plastic film onto which aluminum is laminated or deposited may be used. Examples of the different elements contained in an aluminum alloy include silicon, iron, manganese, copper, magnesium, chromium, zinc, bismuth, nickel and titanium. A content of the different elements in an alloy may be 10% by mass or smaller.

Aluminum which is particularly suitable in the invention is pure aluminum, but since completely pure aluminum is difficult to manufacture from a viewpoint of a refining technique, aluminum may contain a small amount of different elements.

An aluminum plate which is applied to the invention is not limited to an aluminum plate having a specified composition, but an aluminum plate of a material which has conventionally been known and used can be conveniently utilized. A thickness of an aluminum plate used in the invention is around 0.1 mm to 0.6 mm, preferably 0.15 mm to 0.4 mm, particularly preferably 0.2 mm to 0.3 mm.

Such an aluminum plate may be subjected to surface treatment such as surface roughening treatment and anode oxidation treatment, if necessary. Such surface treatment will be simply explained below.

Prior to surface-roughening of an aluminum plate, optionally, degreasing treatment with a surfactant, an organic solvent, an alkaline aqueous solution or the like for removing rolling oil on a surface is performed. Treatment of roughening a surface of an aluminum plate is performed by various methods, for example, a mechanical surface-roughening method, a method of electrochemically dissolving and roughening a surface or a method of chemically and selectively dissolving a surface. As the mechanical surface-roughening method, known methods such as a ball abrading method, a brush abrading method, a blast abrading method and a buff abrading method can be used. As the electrochemical surface-roughening method, there is a method which is performed by an alternating current or a direct current in a hydrochloric acid or nitric acid electrolytic solution. In addition, as disclosed in JP-A No. 54-63902, a method of a combination of both methods may be utilized.

The aluminum plate thus surface-roughened is subjected to alkali etching-treatment and neutralization-treatment if necessary, and thereafter, is subjected to anode oxidation treatment in order to enhance water retention and abrasion resistance of a surface as necessary. As an electrolyte used in anode oxidation treatment of an aluminum plate, various electrolytes which form a porous oxide film can be used, and generally, sulfuric acid, phosphoric acid, oxalic acid, chromic acid or a mixed acid thereof is used. A concentration of those electrolytes is appropriately determined depending on the kind of the electrolytes.

Since treating condition of anode oxidation is variously changed depending on an electrolyte used, it cannot be absolutely specified, but generally, a concentration of an electrolyte of 1 to 80% by mass, a solution temperature of 5 to 70° C., a current density of 5 to 60 A/dm², a voltage of 1 to 100 V, and an electrolysis time of 10 seconds to 5 minutes are suitable. When an amount of an anodic oxide film is less than 1.0 g/m², there is a tendency that printing durability is insufficient, abrasion is easily caused in a non-image area of a planographic printing plate, and so-called “abrasion pollution” that ink is adhered to an abrasion part when printing is easily generated.

After anode oxidation treatment, the aluminum surface is subjected to hydrophilization treatment, if necessary. As hydrophilization treatment used in the invention, there is an alkali metal silicate (e.g. sodium silicate aqueous solution) method disclosed in U.S. Pat. Nos. 2,714,066, 3,181,461, 3,280,734 and 3,902,734.

In this method, a support is subjected to immersion-treatment or electrolysis-treatment with a sodium silicate aqueous solution. Alternatively, a method of treatment with potassium fluoride zirconate disclosed in JP-B No. 36-22063 or a method of treatment with polyvinylphosphonic acid disclosed in U.S. Pat. Nos. 3,276,868, 4,153,461, and 4,689,272 is used.

(Organic Undercoating Layer)

In the planographic printing plate precursor of the invention, an organic undercoating layer may be provided between a support and a recording layer, if necessary.

As an organic undercoating layer component, various organic compounds are used and, for example, the component is selected from carboxymethylcellulose, dextrin, gum arabic, phosphonic acids having an amino group such as 2-aminoethylphosphonic acid, organic phosphonic acids such as phenylphosphonic acid, naphthylphosphonic acid, alkylphosphonic acid, glycerophosphonic acid, methylenediphosphonic acid and ethylenediphosphonic acid each optionally having a substituent, organic phosphoric acids such as phenylphosphoric acid, naphthylphosphoric acid, alkylphosphoric acid and glycerophosphoric acid each optionally having a substituent, organic phosphinic acids such as phenylphosphinic acid, naphthylphosphinic acid, alkylphosphinic acid and glycerophosphinic acid each optionally having a substituent, amino acids such as glycine and β-alanine, and hydrochloride of amine having a hydroxy group such as triethanolamine hydrochloride, and a mixture of two or more kinds thereof may be used.

It is also preferable that the organic undercoating layer contains a compound having an onium group. The compound having an onium group is described in detail in JP-A No. 2000-10292, JP-A No. 2000-108538, and JP-A No. 2000-241962.

Inter alia, preferable examples include at least one compound selected from a group of polymer compounds having a representative structural unit such as poly(p-vinylbenzoic acid) in a molecule. Specific examples include a copolymer of p-vinylbenzoic acid and vinylbenzyltriethylammoium chloride, and a copolymer of p-vinylbenzoic acid and a vinylbenzyltrimethylammonium salt.

The organic undercoating layer can be provided by the following method. That is, there are a method of providing a layer by coating on an aluminum plate a solution in which the aforementioned organic compound is dissolved in water, or an organic solvent such as methanol, ethanol and methyl ethyl ketone or a mixed solvent thereof, followed by drying, and a method of providing an organic undercoating layer by immersing an aluminum plate in a solution in which the aforementioned organic compound is dissolved in water, or an organic solvent such as methanol, ethanol and methyl ethyl ketone or a mixed solvent thereof, to adsorb the compound thereon, thereafter, washing with water, followed by drying. By the former method, a solution having a concentration of the organic compound of 0.005 to 10% by mass can be coated by various methods. In the latter method, a concentration of a solution is 0.01 to 20% by mass, preferably 0.05 to 5% by mass, an immersion temperature is 20 to 90° C., preferably 25 to 50° C., and an immersion time is 0.1 second to 20 minutes, preferably 2 seconds to 1 minute. A solution used therefor may be adjusted to a range of a pH 1 to 12 by using a basic substance such as ammonia, triethylamine and potassium hydroxide, or an acidic substance such as hydrochloric acid and phosphoric acid. For improving reproducibility of a tone of a recording layer, a yellow dye may be added.

A coating amount of the organic undercoating layer is suitably 2 to 200 mg/m², preferably 5 to 100 mg/m². When the coating amount is in the above range, sufficient printing durability is obtained.

The infrared-sensitive planographic printing plate precursor thus manufactured is imagewise exposed to light, and thereafter, is subjected to developing treatment.

[Plate-Making]

An image is formed on the planographic printing plate precursor of the invention by heat. Specifically, direct image recording with a thermal recording head, scanning light exposure with an infrared laser, a high illuminance flash light exposure such as a xenon discharge lamp light exposure, and an infrared lamp light exposure are used, and light exposure with a semiconductor laser which emits infrared-ray at a wavelength of 700 to 1200 nm, or a solid high output infrared laser such as a YAG laser is suitable.

The exposed planographic printing plate precursor of the invention is subjected to developing treatment and post-treatment with a finisher or a protective gum to obtain a printing plate. For these treatments, treating apparatuses such as known automatic developing apparatuses can be used.

Treating agents to be used in developing treatment and post-treatment of the planographic printing plate precursor of the invention can be appropriately selected from known treating agents.

A preferable developer is a developer having a pH in a range of 9.0 to 14.0, preferably in a range of 12.0 to 13.5. As the developer, a conventionally known alkali aqueous solution can be used. Among the alkali aqueous solutions, examples of a particularly preferable developer include a conventionally well-known aqueous solution of a pH of 12 or higher called “silicate developer” containing an alkaline silicate as a base, or containing an alkaline silicate obtained by mixing a base with a silicon compound, and a so-called “non-silicate developer” not containing an alkaline silicate but containing a non-reducing sugar (an organic compound having buffering action) and a base described in JP-A No. 8-305039 and JP-ANo. 11-109637.

It is preferable from a viewpoint of development acceleration and prevention of occurrence of dregs that the developer contains an anionic surfactant and/or an amphoteric surfactant.

When the planographic printing plate of the invention is subjected to burning treatment, it is preferable to perform the treatment using a burning affinitizing solution by a conventionally known method which is performed using a burning processor.

The planographic printing plate obtained by such treatment is subjected to an offset printing apparatus, and is used for printing multiple sheets.

### EXAMPLES

The invention will be described in detail below by way of Examples, but the invention is not limited to them.

### Examples 1 to 9 and Comparative Examples 1 to 4

[Preparation of Support]

(Aluminum Plate)

Using an aluminum alloy containing Si: 0.06% by mass, Fe: 0.30% by mass, Cu: 0.026% by mass, Mn: 0.001% by mass, Mg: 0.001% by mass, Zn: 0.001% by mass and Ti: 0.02% by mass, in which the balance is Al and unavoidable impurities, a molten metal was prepared, molten metal treatment and filtration were performed, and an ingot having a thickness of 500 mm and a width of 1200 mm was prepared by a DC casting method. A surface was cut off at an average thickness of 10 mm with a plane cutting apparatus, the ingot was uniformly thermally retained at 550° C. for about 5 hours, and at the time when the temperature was lowered to 400° C., the ingot was converted into a rolled plate of a thickness of 2.7 mm using a hot rolling apparatus. Further, heat treatment was performed at 500° C. using a continuous annealing apparatus, and the plate was finished to a thickness of 0.24 mm by cold rolling to obtain an aluminum plate of JIS 1050 material. A short diameter of an average crystal particle diameter of the resulting aluminum was 50 μm, and a long diameter was 300 μm. This aluminum plate was converted into a width of 1030 mm, and was subjected to surface treatment as shown below.

<Surface Treatment>

In the surface treatment, various treatments of the following (a) to (k) were continuously performed. After each treatment and washing with water, a liquid was removed with a nip roller.

(a) Mechanical Roughening Treatment

Using a suspension of a polishing agent (pumice) and water of a specific gravity of 1.12 as a polishing slurry liquid, mechanical roughening treatment was performed with rotating roller-type nylon brushes while the slurry liquid was supplied to the surface of the aluminum plate. The average particle diameter of the polishing agent was 30 μm, and the maximum particle diameter was 100 μm. The material of the nylon brushes was 6 10 nylon, the bristle length of the brushes was 45 mm, and the bristle diameter of the brushes was 0.3 mm. In the nylon brushes, bristles were filled densely in perforated stainless cylinders of 300 mm. Three rotation brushes were used. The distance between two supporting rollers (4200 mm) under each of the brushes was 300 mm. The brush rollers were pushed against the aluminum plate until the load of the driving motor rotating the brush became 7 kW larger than the load before the brush rollers were pressed against the aluminum plate. The rotating direction of the brush was the same as the direction of movement of the aluminum plate. The rotation number of the brush was 200 rpm.

(b) Alkali Etching Treatment

The above-obtained aluminum plate was subjected to etching treatment by spraying using an aqueous solution having a concentration of sodium hydroxide of 2.6% by mass and a concentration of aluminum ion of 6.5% by mass at a temperature of 70° C., to dissolve 10 g/m² of the aluminum plate. Thereafter, the plate was washed with water by spraying.

(c) Desmut Treatment

Desmut treatment was performed by spraying with an aqueous solution having a nitric acid concentration of 1% by mass (containing 0.5% by mass of aluminum ion) at a temperature of 30° C. and, thereafter, the plate was washed with water by spraying. As a nitric acid aqueous solution used in desmut treatment, a waste solution in the step of performing electrochemical surface roughening treatment using alternating current in a nitric acid aqueous solution was used.

(d) Electrochemical Surface Roughening Treatment

Using 60 Hz alternating voltage, electrochemical surface roughening treatment was performed continuously. At that time, the electrolytic solution was a nitric acid 10.5 g/L aqueous solution (containing 5 g/L of aluminum ion and 0.007% by mass of ammonium ion), and the solution temperature was 50° C. At TP (a time from zero of a current value to a peak of a current value) of 0.8 msec and the duty ratio of 1:1 and using trapezoid wave alternating current, electrochemical surface roughening treatment was performed with a carbon electrode as a counter electrode. As an auxiliary anode, ferrite was used. As an electrolysis tank, a radial cell type was used.

The current density was 30 A/dm² when the current was at the peak, and the quantity of electricity was 220 C/dm² as expressed by a sum of a quantity of electricity when the aluminum plate was an anode. 5% of the current flown from an electric source was flown into the auxiliary anode. Thereafter, washing with water was performed by spraying.

(e) Alkali Etching Treatment

The aluminum plate was subjected to etching treatment by spraying at 32° C. using an aqueous solution having a concentration of sodium hydroxide of 26% by mass and a concentration of aluminum ion of 6.5% by mass, to dissolve 0.50 g/m² of the aluminum plate, a smut component mainly containing aluminum hydroxide generated at the previous electrochemical surface roughening treatment using alternating current was removed, and an edge part of a produced pit was dissolved to make the edge part smooth. Thereafter, washing with water was performed by spraying.

(f) Desmut Treatment

Desmut treatment was performed by spraying with an aqueous solution having a nitric acid concentration of 15% by mass (containing 4.5% by mass of aluminum ion) at a temperature of 30° C. and, thereafter, washing with water was performed by spraying. As a nitric acid aqueous solution used in the desmut treatment, a waste solution of a step of performing electrochemical surface roughening treatment using alternating current in a nitric acid aqueous solution was used.

(g) Electrochemical Surface Roughening Treatment

Using 60 Hz alternating voltage, electrochemical surface roughening treatment was performed continuously. At that time, the electrolytic solution was a hydrochloric acid 5.0 g/L aqueous solution (containing 5 g/L of aluminum ion), and the temperature was 35° C. At TP (a time from a zero of a current value to a peak of a current value) of 0.8 msec and a duty ratio of 1:1 and using trapezoid wave alternating current, electrochemical surface roughening treatment was performed using a carbon electrode as a counter electrode. As an auxiliary anode, ferrite was used. As an electrolysis tank, a radial cell type was used.

The current density was 25 A/dm² when the current was at the peak, and the quantity of electricity was 50 C/dm² as expressed by a sum of a quantity of electricity when the aluminum plate was an anode. Thereafter, washing with water was performed by spraying.

(h) Alkali Etching Treatment

The aluminum plate was subjected to etching treatment by spraying at 32° C. using an aqueous solution having a concentration of sodium hydroxide of 26% by mass and a concentration of aluminum ion of 6.5% by mass, to dissolve 0.10 g/m² of the aluminum plate, a smut component mainly containing aluminum hydroxide generated at the previous electrochemical surface roughening treatment using alternating current was removed, and an edge part of a produced pit was dissolved to make the edge part smooth. Thereafter, washing with water was performed by spraying.

(i) Desmut Treatment

Desmut treatment was performed by spraying with an aqueous solution having a sulfuric acid concentration of 25% by mass (containing 0.5% by mass of aluminum ion) at a temperature of 60° C. and, thereafter, washing with water was performed by spraying.

(j) Anode Oxidation Treatment

Using an anode oxidation device (first and second electrolysis part length each 6 m, first and second electricity supplying part length each 3 m, first and second electricity supplying electrode part length each 2.4 m) of a two-step electricity supplying electrolysis treating method, anode oxidation treatment was performed. As an electrolytic solution to be supplied to first and second electrolysis parts, sulfuric acid was used. All electrolytic solutions had a sulfuric acid concentration of 50 g/L (containing 0.5% by mass of aluminum ion), and the temperature was 20° C. Thereafter, washing with water was performed by spraying. A final oxide film amount was 2.7 g/m².

(k) Alkali Metal Silicate Salt Treatment

Alkali metal silicate salt treatment (silicate treatment) was performed by immersing the aluminum support obtained by the anode oxidation treatment in a treating tank containing a No. 3 sodium silicate 1 mass % aqueous solution at a temperature of 30° C. for 10 seconds. Thereafter, washing with water was performed by spraying using well water, to obtain a support having a silicate hydrophilization-treated surface for an infrared-sensitive planographic printing plate.

[Formation of Back Coating Layer (Organic Polymer Layer)]

In examples 1 through 9, an organic polymer layer coating solution containing an epoxy resin or resole resin, a crosslinking agent, a surfactant (fluorinated surfactant B) and a solvent was prepared. On a surface (back surface) of the above obtained support at a side opposite to a side where a recording layer was to be coated, the organic polymer layer coating solution was coated by use of a bar coater with an wet amount controlled so as to form a film of 2 μm after drying, followed by heating at 140° C. for 3 min to dry and form a film with a crosslinked structure, whereby an organic polymer layer was formed.

Back coating solution

| | |
|---|---|
| Particular thermosetting resin (as described in | 10 g |
| Table 1) | |
| Crosslinking agent (as described in Table 1) | (an amount described |
| | in Table 1) |
| Surfactant (fluorinated surfactant B with a | 0.05 g |
| structure shown below) | |
| Solvent methyl ethyl ketone | 100 g |

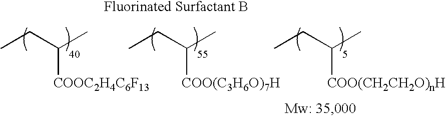

In comparative examples 1 through 3 as well, with back coating solutions with compositions shown in Table 1, back coating layers were formed.

In comparative example 4, a back coating layer was not formed.

Manufacturers and distributors of the epoxy resins, resole resins and crosslinking agents (commercially available products) used in Table 1 below are as follows.

TABLE 1

| | | | | | | Occurrence of | | |
|---|---|---|---|---|---|---|---|---|
| | Particular thermosetting resin or comparative resin | | | Crosslinking agent | | rubbing | | |
| | | | Epoxy | | Addition | abrasion | | |
| | | Name | equivalent | | amount | due to | Chemical | Heat |
| | Classification | (Name of product) | (g/eq) | Name | (g) | transportation | resistance | resistance |
| Example 1 | Bisphenol A | Epicoat 828 *1 | approximately | Triethylenetetramine | 1.7 | A | A | A |
| | type epoxy | | 190 | | | | | |
| Example 2 | resin | Epicoat 1001 *1) | approximately | Triethylenetetramine | 0.7 | A | A | A |
| | | | 480 | | | | | |
| Example 3 | | Epicoat 1004 *1) | approximately | Triethylenetetramine | 0.35 | A | A | A |
| | | | 925 | | | | | |
| Example 4 | | Epicoat 1009 *1) | approximately | Triethylenetetramine | 0.12 | A | A | A |
| | | | 2800 | | | | | |
| Example 5 | | Epicoat 1001 *1) | approximately | Epicure T1 *3) | 5 | A | A | A |
| | | | 480 | | | | | |
| Example 6 | | Epicoat 1001 *1) | approximately | Epicure 3012PF *3) | 10 | A | A | A |
| | | | 480 | | | | | |
| Comparative | | Epicoat 1001 *1) | approximately | Nothing | — | A | B | B |
| Example 1 | | | 480 | | | | | |
| Example 7 | Bisphenol F | Epicoat 4004P | approximately | Triethylenetetramine | 1.7 | A | A | A |
| | type epoxy | *1) | 880 | | | | | |
| | resin | | | | | | | |
| Example 8 | Resole resin | Sumilight Resin | — | P-toluene sulfonic | 0.5 g | A | A | A |
| | | PR-9480 *2) | | acid | | | | |
| Example 9 | | Sumilight Resin | — | P-toluene sulfonic | 0.5 g | A | A | A |
| | | PR-51904 *2) | | acid | | | | |
| Comparative | | Sumilight Resin | — | Nothing | — | A | B | B |
| Example 2 | | PR-9480 *2) | | | | | | |
| Comparative | Polystyrene | | — | Nothing | — | A | B | B |
| Example 3 | (Mw 100000) | | | | | | | |
| Comparative | Nothing | | — | Nothing | — | B | A | A |
| Example 4 | | | | | | | | |

*1) Epoxy resin manufactured by Japan Epoxy Resin Co., Ltd.
*2) Resole resin manufactured by Sumitomo Bakelight Co., Ltd.
*3) Crosslinking agent for epoxy resin manufactured by Japan Epoxy Resin Co., Ltd.

<Formation of Organic Undercoat Layer>

On a surface-treated surface of the support, which is at a side opposite to a side at which the organic polymer layer was formed, an organic undercoat solution described below was coated with a bar coater and dried at 80° C. for 15 sec, whereby an organic undercoat layer was disposed so that a dry coating amount was 18 mg/m².

Organic Undercoat Solution

| | |
|---|---|
| Polymer shown below | 0.3 g |
| Methanol | 100 g |

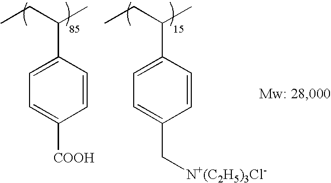

[Formation of Recording Layer]

On the aluminum support on which an organic undercoat layer was formed, a lower layer coating solution 1 shown below was coated with a bar coater so that a dry coating amount was 0.85 g/m², dried at 160° C. for 44 sec, and then immediately cooled with cold air at 17 to 20° C. until a temperature of the support became 35° C., whereby a lower layer was formed. Thereafter, an uppermost layer coating solution 1 shown below was coated by use of a bar coater so that a dry coating amount was 0.22 g/m², dried at 148° C. for 25 sec and gradually cooled with air at 20 to 26° C., whereby an uppermost layer was formed.

<Composition of Lower Layer Coating Solution>

| | | |
|---|---|---|
| N-(4-aminosulfonylphenyl)methacrylamide/acrylonitrile/ | 2.1 | g |
| methyl methacrylate (36/34/30 wt %: weight average | | |
| molecular weight 50000, acid value 2.65) | | |
| m,p-cresol novolak (m/p ratio = 6/4, weight average | 0.1 | g |
| molecular weight 4500, containing 0.8% by mass of | | |
| unreacted cresol, Tg 75° C.) | | |
| Cyanine dye A (with a structure shown below) | 0.13 | g |
| 4,4′-bishydroxyphenyl sulfone | 0.13 | g |
| Tetrahydrophthalic acid anhydride | 0.19 | g |
| P-toluene sulfonic acid | 0.008 | g |
| 3-methoxy-4-diazodiphenylamine hexafluorophosphate | 0.032 | g |
| Ethyl violet wherein a counter ion was changed to | 0.078 | g |
| 6-hydroxy-2-naphthalene sulfonic acid | | |
| Fluorinated surfactant B (with the structure shown above) | 0.007 | g |
| Methyl ethyl ketone | 25.0 | g |
| 1-methoxy-2-propanol | 13.0 | g |
| γ-butylolactone | 13.0 | g |

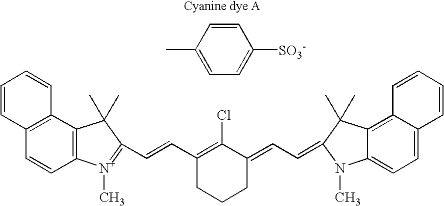

<Composition of Uppermost Layer Coating Solution>

Phenol/m-cresol/p-cresol novolak (molar ratio=5/3/2, weight average molecular weight:

| | |
|---|---|
| 5000, unreacted cresol: 1.2% by mass, Tg: 70° C.) | 0.35 g |
| Acrylic resin C (with a structure shown below) | 0.042 g |
| Cyanine dye A (with the structure shown above) | 0.019 g |
| Ammonium compound D (with a structure shown below) | 0.004 g |
| Sulfonium compound G (with the structure shown below) | 0.032 g |
| Fluorinated surfactant B (with the structure shown above) | 0.0045 g |
| Fluorinated surfactant E (with a structure shown below) | 0.0033 g |
| Fluorinated polymer F (with a structure shown below) | 0.018 g |
| Methyl ethyl ketone | 10.0 g |
| 1-methoxy-2-propanol | 20.0 g |

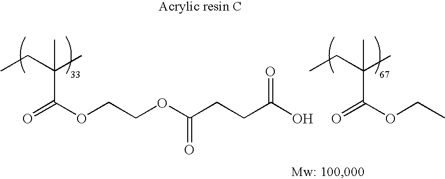

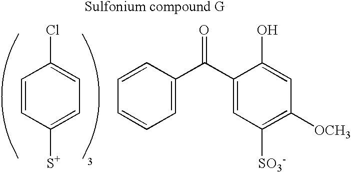

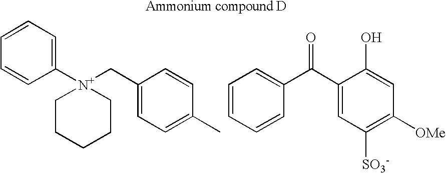

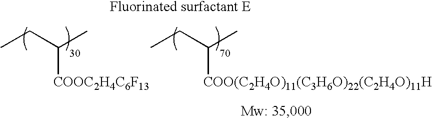

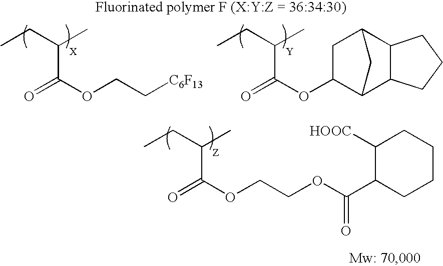

<Evaluation>

With the respective infrared-sensitive planographic printing plate precursors obtained in examples and comparative examples, the respective items of [1. Occurrence of rubbing abrasion due to transportation], [2. Chemical resistance], and [3. Heat resistance (burning resistance)] were evaluated. Results are shown in the Table 1.

1. Evaluation of Occurrence of Rubbing Abrasion Due to Transportation

Each of the obtained infrared-sensitive planographic printing plate precursors was cut to 1030 mm×800 mm size, 30 sheets of which were stacked without interleaving sheets. Cardboard having a thickness of 0.5 mm was placed on each of the top and bottom of the stack, and then each of the four corners of the stack was fixed with tape. After that, the stack was wrapped with aluminum craft paper, enclosed in a cardboard casing, and taped to obtain an interleaving sheet-less packaging form. This was placed on a palette, transported 2000 km by a truck, and opened. After being opened, the infrared-sensitive plangraphic printing plate precursor was development-treated at a development temperature of 32° C. for a development time of 12 seconds in a developer DT-2 manufactured by Fuji Photo Film Co., Ltd. diluted at 1:8 using an automatic developing apparatus LP-940HII manufactured by Fuji Photo Film Co., Ltd. At that time, the electric conductivity of the developer was 43 mS/cm. The presence or the absence of missing portions in an image area of the developed planographic printing plate resulting from transportation was visually observed for evaluation. Absence of missing portions in an image area is designated by “A”, and presence of missing portions in an image area is designated by “B”. Results are shown in Table 1.

2. Evaluation of Chemical Resistance

On the back surface (the surface on which the back coating layer was coated) of each infrared-sensitive planographic printing plate precursor placed on a level table, approximately 0.5 ml of a plate cleaner for UV ink, Daicure P (trade name, manufactured by Dainippon Ink and Chemicals, Incorporated), was dripped and left to stand for two min. Thereafter, Daicure was washed away with water, followed by visually observing the extent the back coating layer was affected, and evaluation was carried out according to the following criteria. Results are shown in Table 1.

A: No trace of where Daicure P was dripped was found.

B: A trace of where Daicure P was dripped was found. (Damage was found.)

3. Evaluation of Heat Resistance (Burning Resistance)

Each infrared-sensitive planographic printing plate precursor was cut to 1030 mm×800 mm size, followed by heating at 270° C. for 3 min with a back surface directed upward in a burning processor (trade name: Wisconsin Oven SPC-34-HTS/109; manufactured by Wisconsin Co., Ltd.). The change due to heating was visually observed and evaluated according to the following criteria. Results are shown in Table 1.

A: No change in uniformity of the film surface between before and after the heating was observed.

B: The back coating layer was melted due to heating, resulting in an irregular film surface.

As shown in Table 1, it was found that the infrared-sensitive planographic printing plate precursors of examples, even when stacked and packaged without using interleaving sheets, were excellent in transportation suitability as well as in chemical resistance and heat resistance.

The present invention provides at least the following embodiments 1 to 10.

1. An infrared-sensitive planographic printing plate precursor comprising:

a support;

a recording layer on one surface of the support, which recording layer contains a water-insoluble and alkali-soluble resin and an infrared absorber, and is capable of forming an image by infrared irradiation; and

an organic polymer layer on the other surface of the support, which organic polymer layer is formed by coating and drying a solution that contains at least one organic polymer selected from epoxy resins and resole resins, and a crosslinking agent.

2. The infrared-sensitive planographic printing plate precursor of embodiment 1, wherein the organic polymer is an epoxy resin.

3. The infrared-sensitive planographic printing plate precursor of embodiment 2, wherein a content of the epoxy resin in the organic polymer layer is in the range of 30 to 99.7% by mass in terms of solid content.

4. The infrared-sensitive planographic printing plate precursor of embodiment 1, wherein the crosslinking agent is at least one selected from the group consisting of amines, imidazoles, acid anhydrides and phenols.

5. The infrared-sensitive planographic printing plate precursor of embodiment 1, wherein the organic polymer is a resole resin.

6. The infrared-sensitive planographic printing plate precursor of embodiment 5, wherein a content of the resole resin in the organic polymer layer is in the range of 30 to 99.7% by mass in terms of solid content.

7. The infrared-sensitive planographic printing plate precursor of embodiment 5, wherein the crosslinking agent is an organic acid or an inorganic acid.

8. The infrared-sensitive planographic printing plate precursor of embodiment 1, wherein a thickness of the organic polymer layer is in the range of 0.3 to 25 μm.

9. The infrared-sensitive planographic printing plate precursor of embodiment 1, wherein the dynamic friction coefficient between a surface of the organic polymer layer and a surface of the recording layer, which is measured in accordance with the standard ASTM D1894, is in the range of 0.38 to 0.70.

10. The infrared-sensitive planographic printing plate precursor of embodiment 1, wherein the support is an aluminum plate.

What is claimed is:

1. An infrared-sensitive planographic printing plate precursor comprising:
a support;
a recording layer on one surface of the support, which recording layer contains a water-insoluble and alkali-soluble resin and an infrared absorber, and is capable of forming an image by infrared irradiation; and
an organic polymer layer on the other surface of the support, which organic polymer layer is formed by coating and drying a solution that contains at least one organic polymer selected from epoxy resins and resole resins, and a crosslinking agent.

2. The infrared-sensitive planographic printing plate precursor of claim 1, wherein the organic polymer is an epoxy resin.

3. The infrared-sensitive planographic printing plate precursor of claim 2, wherein a content of the epoxy resin in the organic polymer layer is in the range of 30 to 99.7% by mass in terms of solid content.

4. The infrared-sensitive planographic printing plate precursor of claim 1, wherein the crosslinking agent is at least one selected from the group consisting of amines, imidazoles, acid anhydrides and phenols.

5. The infrared-sensitive planographic printing plate precursor of claim 1, wherein the organic polymer is a resole resin.

6. The infrared-sensitive planographic printing plate precursor of claim 5, wherein a content of the resole resin in the organic polymer layer is in the range of 30 to 99.7% by mass in terms of solid content.

7. The infrared-sensitive planographic printing plate precursor of claim 5, wherein the crosslinking agent is an organic acid or an inorganic acid.

8. The infrared-sensitive planographic printing plate precursor of claim 1, wherein a thickness of the organic polymer layer is in the range of 0.3 to 25 μm.

9. The infrared-sensitive planographic printing plate precursor of claim 1, wherein the dynamic friction coefficient between a surface of the organic polymer layer and a surface of the recording layer, which is measured in accordance with the standard ASTM D1894, is in the range of 0.38 to 0.70.

10. The infrared-sensitive planographic printing plate precursor of claim 1, wherein the support is an aluminum plate.
